(19) United States
(12) Patent Application Publication
(10) Pub. No.: US 2006/0157904 A1
(43) Pub. Date: Jul. 20, 2006

(54) Apparatus for fixing a workpiece and fixing unit thereof

(76) Inventors: Yu-Chi Li, Taipei (TW); Kyi-Lyan Lee, Taipei (TW); Chun-Yi Cheng, Taipei (TW)

Correspondence Address: RABIN & Berdo, PC, 1101 14TH STREET, NW, SUITE 500, WASHINGTON, DC, 20005, US

(21) Appl. No.: 11/333,215

(22) Filed: Jan. 18, 2006

(30) Foreign Application Priority Data
Jan. 19, 2005 (TW) 94101606

(51) Int. Cl. B25B 11/00

(52) U.S. Cl. 269/8

(57) ABSTRACT

An apparatus for fixing a workpiece by a magnetic force includes a carrier and a fixing unit. The carrier is made of a magnetic material. The fixing unit is disposed on the workpiece, fixing the workpiece on the carrier. The fixing unit includes a supporting portion, a magnet and a connecting portion. The magnet is disposed in the supporting portion. The connecting portion is connected to the supporting portion and is used for being joined to the workpiece. The fixing unit is fixed on the carrier by a magnetic force, for fixing the workpiece on the carrier.

This application claims the benefit of Taiwan application Serial No. 94101606, filed Jan. 19, 2005, the subject matter of which is incorporated herein by reference.

### BACKGROUND OF THE INVENTION

1. Field of the Invention

The Invention relates to a jig and a fixing unit thereof, and more particularly to an apparatus for fixing a workpiece on a carrier by a magnetic force and a fixing unit thereof.

2. Description of the Related Art

A jig fixes a workpiece in order to carry out various tests on the workpiece. Generally, the jig includes a carrier and a fixing unit. A common fixing method was to align the fixing hole of the workpiece with the fixing hole of the carrier, and use the fixing units, such as rivets and screws, to lock the workpiece on the carrier. Another common fixing method was to fix the fixing units with the jointing surface to the fixing hole of the workpiece. Then the jointing surface of the fixing unit is wedged with the groove of the carrier to fix the workpiece on the carrier. However, the fixing holes of different workpieces are not always at the same position. Therefore, when testing different workpieces, new carriers have to be made for matching up the position of the fixing holes of the workpieces. The carrier is unable to be reused and therefore the testing cost increases. If workpieces with different sizes and types are to be tested, it is necessary to design various carriers. Inconveniently, a user has to carry several carriers and workpieces to the client for testing. Besides, the operating method of the conventional jig was locking or wedging to fix the workpiece on the carrier. It is not handy to use because much longer time is spent to removing the workpiece from the carrier.

### SUMMARY OF THE INVENTION

It is an object of the invention to provide an apparatus for fixing a workpiece and the fixing unit thereof. The workpiece is fixed on the carrier by a magnetic force existed between the magnetic fixing unit and the carrier made of a magnetic material. The apparatus is reusable, so that the workpieces of different sizes can be fixed on the apparatus for carrying out testing. Therefore, it is easy and handy for users and can save the cost of re-manufacture the apparatus.

One embodiment of the invention achieves the above-identified object by providing an apparatus for fixing a workpiece. The apparatus includes a carrier and a fixing unit. The carrier is made of a magnetic material. The fixing unit is disposed on the workpiece for fixing the workpiece on the carrier. The fixing unit includes a supporting portion and a connection portion. The supporting portion is magnetic-attractable. The connection portion is connected to the supporting portion is used for being joined to the workpiece. The fixing unit is fixed on the carrier by a magnetic force so as to fix the workpiece on the carrier.

Another embodiment of the invention achieves the above-identified object by providing a fixing unit used to be disposed on a workpiece, so that the workpiece is fixed on the carrier. The carrier is made of a magnetic material. The fixing unit includes a supporting portion, a magnet and a connection portion. The magnet is disposed in the supporting portion. The connection portion is connected to the supporting portion and is used for being joined to the workpiece. The fixing unit is fixed to the carrier by a magnetic force so as to fix the workpiece on the carrier.

Another embodiment of the invention achieves the above-identified object by further providing a fixing unit, which is disposed on a workpiece to fix the workpiece on the carrier. The carrier is made of a magnetic material. The fixing unit includes a supporting portion, a magnet and a connection portion. The supporting portion and the connection portion are columnar. The magnet is disposed in the supporting portion. One end of the connection portion is connected to the supporting portion, and the other end is used for being joined to the workpiece. The fixing unit is fixed on the carrier by a magnetic force so as to fix the workpiece on the carrier.

Another embodiment of the invention achieves the above-identified object by providing another fixing unit, which is used to be disposed on the workpiece, so that the workpiece is fixed on the carrier. The carrier is made of a magnetic material. The fixing unit includes a supporting portion, a magnet and a connection portion. The magnet is disposed in the supporting portion. The connection portion is connected to the supporting portion and is used for being joined to the workpiece. The fixing unit is substantially in an L shape. When the fixing unit is disposed on the workpiece, the fixing unit is fixed on the carrier by a magnetic force so as to fix the workpiece on the carrier.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is three-dimensional view of an apparatus for fixing a workpiece according to the preferred embodiment of the present invention.

FIG. 2 is three-dimensional view of the first fixing unit in the FIG. 1.

FIG. 3A is three-dimensional view of the first embodiment of the second fixing unit.

FIG. 3B is three-dimensional view of the second embodiment of the second fixing unit.

### DETAILED DESCRIPTION OF THE INVENTION

The apparatus according to the preferred embodiment of the present invention is used for fixing a workpiece. The apparatus includes a carrier and a fixing unit. The carrier is made of a magnetic material. It has to be understood that the “magnetic material” is generalized. It intended to cover any material, which can attract or be attracted by magnet. The fixing unit includes a supporting portion, a magnet and a connection portion. The magnet is disposed in the supporting portion and the connection portion is connected to the supporting portion. In order to fix the workpiece on the carrier, the connection portion of the fixing unit is joined to the workpiece. Therefore, the fixing unit is able to be attracted to the carrier by the magnetic force between the magnet of the fixing unit and the carrier.

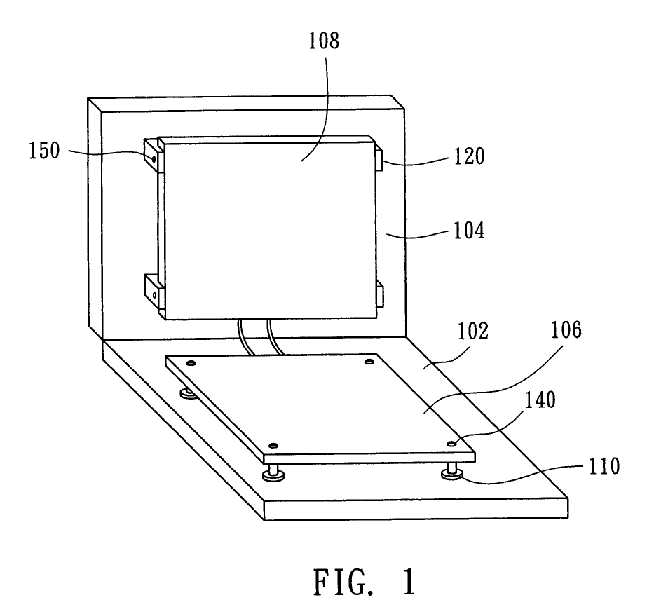

Referring the FIG. 1, a three-dimensional diagram of the apparatus is shown according to the preferred embodiment of the present invention. The carrier includes a lower carrier 102 and an upper carrier 104. The lower carrier 102 and the upper carrier 104 are made of a magnetic material. The magnetic material covers all material, which is able to be attracted by the magnet such as iron, nickel, cobalt and compound metal. Upper carrier 104 could be hinged to the lower carrier 102, and the upper carrier 104 could foldably cover the lower carrier 102.

Preferably, the workpiece is able to be fixed on either the lower carrier 102 or the upper carrier 104 by connecting the fixing unit and the workpiece. The fixing unit includes the fixing unit 110 or the second fixing unit 120.

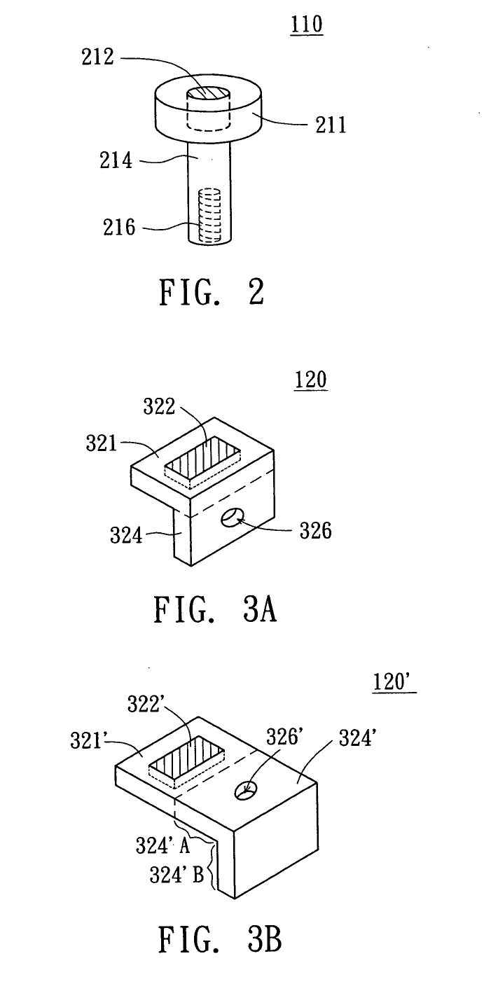

Referring to FIG. 2, the three-dimensional diagram of the first fixing unit 110 depicted in the FIG. 1 is shown. The first fixing unit 110 includes the first supporting portion 211, the first magnet 212 and the first connection portion 214. Generally, the first supporting portion 211 and the first connection portion 214 are columnar such as cylinder. The first magnet 212 is disposed in the first supporting portion 211. One end of the first connection portion 214 connects to the first supporting portion 211. The other end of the first connection portion 214 is for joining to the workpiece by, for example, locking. The first connection portion 214 has a thread slot 216. The inner wall of the thread slot 216 has a plurality of screw threads for locking a screw therein so that the first fixing unit 110 is locked on the workpiece. Furthermore, the first supporting portion 211 and the first connection portion 214 could be integrally formed. The so-called locking means join different objects by the way of locking with a screw.

Refer to the FIG. 1, which shows the second fixing unit 120 is substantially in the form of L. Referring to the FIG. 3A, the structure of the second fixing unit is further illustrated, and a three-dimensional diagram of the first embodiment of the second fixing unit 120 is shown. The second fixing unit 120 includes the second supporting portion 321, the second magnet 322 and the second connection portion 324. The second magnet 322 is disposed in the second supporting portion 321. The second connection portion 324 is connected to the second supporting portion 321 and is used for being joined to the workpiece by, for example, wedging and locking. In other words, the second connection portion 324 has a through hole 326. The through hole 326 is used for locking a screw therein. When the second fixing unit 120 is disposed on the workpiece, the second fixing unit 120 is fixed on the carrier by a magnetic force, for fixing the workpiece on the carrier.

The second supporting portion 321 and the second connection portion 324 could be integrally formed. Refer to the FIG. 3A, which shows the second connection portion 324 is perpendicularly connected to the one end of the second supporting portion 321, so that the second fixing unit 120 is substantially in the form of L. However, the second connection portion is able to be connected to the second supporting portion by different ways, which makes the second fixing unit is in the form of L. Refer to the FIG. 3B, which shows the three-dimensional view of the second embodiment of the second fixing unit. In the second fixing unit 120′, the second connection portion 324′ includes the first flat plate 324′A and the second flat plate 324′B and the two flat plates 324′A and 324′B are present as the form of L. The first flat plate 324′A of the second connection portion 324′ has the through hole 326′ and the first flat plate is connected to and level with the second supporting portion 321′. So the second fixing unit 120′ is substantially in the form of L. The difference between the first embodiment and the second embodiment of the second fixing unit lies in that, in the first embodiment, the through hole 326 and the magnet 322 are located in different flat surfaces which are substantially perpendicular to each other. Yet in the second embodiment, the through hole 326′ and the magnet 322′ are located on different flat surfaces but level with each other.

Refer to the FIG. 2, FIG. 3A and 3B, which show that the first magnet 212, the second magnet 322 and the second magnet 322′ could be a magnet or electromagnet. An electromagnet generates the magnetic force by electricity, for fixing the fixing unit on the carrier. The electromagnet includes the iron core and the coil, the coil winding the iron core.

Refer to FIG. 1, FIG. 2, and FIG. 3A. The workpiece applied in the embodiment could be various types of electronic products. A motherboard 106 acted as the workpiece and the LCD display are taken as examples. However, this example will not limit the scope of the appended claim of the present invention. The motherboard 106 is coupled with the LCD display 108, and the motherboard 106 has several fixing holes originally. The motherboard 106 could be fixed on the carrier by using the first fixing unit 110. The screw 140 penetrates the fixing hole of the motherboard to be locked in the thread slot 216, so that the first fixing unit 110 is fixed on the motherboard 106. After the first fixing unit 110 is fixed on the motherboard 106, the motherboard 106 is fixed on the lower carrier 102 by the magnetic force of the first fixing unit 110 so as to attract the lower carrier 102.

The lateral side of the LCD display 108 has several fixing holes. The LCD display 108 could be fixed on the carrier by the second fixing unit 120 shown in FIG. 3A. By means of a screw penetrating the through hole 326 and the fixing hole of the lateral side of the LCD display 108, the second fixing unit 120 is wedged and locked to the lateral side of the LCD display 108. After the second fixing unit 120 is wedged and locked to the lateral side of the LCD display 108, the LCD display 108 is fixed on the carrier 104 by the magnetic force of the second fixing unit 120 so as to attract the upper carrier 104.

Similarly, if the base of the LCD display 108 has several fixing holes, the LCD display 108 could be fixed on the carrier by the second fixing unit 120′ shown in the FIG. 3B. By means of the screw 150 penetrating the through hole 326′ and the fixing hole of the base of the LCD display 108, the second fixing unit 120′ is wedged and locked to one base of the LCD display 108. Therefore, the LCD display 108 is fixed on the upper carrier 104.

When the supporting portion and the connection portion of the fixing unit are made of plastic, the motherboard 106 and the LCD display 108 is insulated against the lower carrier 102 and the upper carrier 104, respectively. Hence, the motherboard 106 and the LCD display 108 could be tested on the general electrical functions. For example, testing whether the motherboard 106 could function properly and the correct image could be displayed on the LCD display 108. The proper angle between the upper carrier 104 and the lower carrier 102 enables users to view the image shown on the LCD display 108. When the supporting portion and the connection portion of the fixing unit are made of metal, the apparatus' materials are conductive. Therefore, the motherboard 106 and the LCD display 108 are able to couple with the lower carrier 102 and the upper carrier 104, respectively. So the lower carrier 102 and the upper carrier 104 could be simulated as the casing of the notebook and then act as grounding surface. Thereupon, the apparatus is especially suitable for testing the motherboard 106 and the LCD display 108 on the electromagnetic interference (EMI).

The apparatus according to the preferred embodiment disclosed above is fixed on the workpiece by the magnetic fixing unit in the first place. Then the workpiece is fixed on the carrier by the magnetic force so that various tests could be carried out. In the preferred embodiment of the present invention, the lower carrier and the upper carrier are made of a magnetic material, so the workpiece can be fixed at any position on the lower carrier and the upper carrier. Therefore, it is not needed to drill fixing holes on the lower carrier and the upper carrier. The apparatus for fixing a workpiece of the preferred embodiment of the present invention is reusable so that the cost for reproducing the carrier is significantly reduced. It is very easy and handy for users that they only need to bring one carrier to the client for testing a plurality of workpieces if different workpieces are to be tested. In addition, the workpiece of the preferred embodiment of the present invention is fixed on the lower carrier and the upper carrier by the magnetic force of the fixing unit. Therefore, when removing the workpiece from the lower carrier or the upper carrier, the smallest external force is simply required to be bigger than the magnetic force. Fixing the workpiece by the magnetic force not only saves much working time, but also facilitates its usage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for fixing a workpiece, comprising:
a carrier made of a magnetic material; and
a fixing unit disposed on the workpiece for fixing the workpiece on the carrier, the fixing unit comprising:
a supporting portion that is magnetic-attractable; and
a connection portion connected to the supporting portion, for being joined to the workpiece;
wherein the fixing unit is fixed on the carrier by a magnetic force to fix the workpiece on the carrier.

2. The apparatus according to claim 1, wherein the supporting portion and the connection portion are made of plastics, thereby testing the workpiece on general electrical functions when the workpiece is fixed on the carrier.

3. The apparatus according to claim 1, wherein the supporting portion and the connection are made of metal, thereby testing the workpiece on electromagnetic interference when the workpiece is fixed on the carrier.

4. The apparatus according to claim 1, wherein the fixing unit is used for being locked to the workpiece.

5. The apparatus according to claim 1, wherein the fixing unit is used for being wedged and locked to one lateral side of the workpiece.

6. The apparatus according to claim 1, wherein the fixing unit includes a magnet disposed in the supporting portion.

7. The apparatus according to claim 6, wherein the magnet is an electromagnet, which comprises an iron core and a coil, the coil winding the iron core and the electromagnet being fixed on the carrier by a magnetic force generated by electricity.

8. The apparatus according to claim 1, wherein the supporting portion and the connection portion are integrally formed.

9. The apparatus according to claim 1, wherein the carrier comprises:
a lower carrier; and
an upper carrier hinged to the lower carrier and foldably covering the lower carrier.

10. The apparatus according to claim 8, wherein when the workpiece is fixed on the carrier, the workpiece is fixed either on the upper carrier or the lower carrier.

11. The apparatus according to claim 1, wherein the supporting portion and the connection portion are cylinder-shaped, one end of the connection portion is connected to the supporting portion, and the other end of the connection portion is used for being joined to the workpiece.

12 The apparatus according to claim 1, wherein the fixing unit is substantially in an L shape.

13. A fixing unit to be disposed on a workpiece for fixing the working piece on a carrier made of a magnetic material, the fixing unit comprising:
a supporting portion that is magnetic-attractable; and
a connection portion connected to the supporting portion for being joined to the workpiece;
wherein the fixing unit is fixed on the carrier by a magnetic force so as to fix the workpiece on the carrier.

14. The fixing unit according to claim 13, where the supporting portion and the connection portion are made of plastics, thereby testing the workpiece on general electrical functions when the workpiece is fixed on the carrier.

15. The fixing unit according to claim 13, where the supporting potion and the connection portion are made of metal, thereby testing the workpiece on electromagnetic interference when the workpiece is fixed on the carrier.

16. The fixing unit according to claim 13, where the fixing unit is used for being locked to the workpiece.

17. The fixing unit according to claim 13, where the fixing unit is used for being wedged and locked to one lateral side of the workpiece.

18. The fixing unit according to claim 13, further comprising a magnet disposed in the supporting portion.

19. The fixing unit according to claim 18, wherein the magnet is an electromagnet, which comprises an iron core and a coil, the coil winding the iron core and the electromagnet being fixed on the carrier by a magnetic force generated by electricity.

20. The fixing unit according to claim 13, wherein the supporting portion and the connection portion are integrally formed.

21. The fixing unit according to claim 13, wherein the supporting portion is columnar; and the connection portion is columnar, one end of the connection portion being connected to the supporting portion and the other end used for being joined to the workpiece.

22. The fixing unit according to claim 21, wherein the other end of the connection portion has a thread slot and an inner wall of the thread slot has a plurality of screw threads, for screwing a screw therein.

23. The fixing unit according to claim 22, wherein the workpiece has a fixing hole, and the screw is used to secure the fixing hole and the thread slot, for fixing the fixing unit on the workpiece.

24. A fixing unit being disposed on a workpiece, for fixing the workpiece on a carrier, which is made of a magnetic material, the fixing unit comprising:
a supporting portion;
a magnet disposed in the supporting portion; and
a connection portion connected to the supporting portion, for being joined to the workpiece;
wherein the fixing unit is substantially L-shaped, and the fixing unit is fixed on the carrier by a magnetic force when the fixing unit disposed on the workpiece so as to fix the workpiece on the carrier.

25. The fixing unit according to claim 24, wherein the connection portion has a through hole and the workpiece has a fixing hole, the fixing unit being fixed on the workpiece by screwing a screw through the through hole and the fixing hole.

26. The fixing unit according to claim 24, wherein the magnet is an electromagnet including an iron core and a coil, the coil winding the iron core, the electromagnet being fixed on the carrier by a magnetic force generated by electricity.

27. The fixing unit according to claim 24, wherein the supporting portion and the connection portion are integrally formed.
